(19) United States
(12) Patent Application Publication
(10) Pub. No.: US 2025/0368274 A1
(43) Pub. Date: Dec. 4, 2025

(54) VEHICLE FRONT STRUCTURE

(71) Applicants: Hyundai Motor Company, Seoul (KR); Kia Corporation, Seoul (KR)

(72) Inventors: Eui Jung Chung, Hwaseong-si (KR); Hyeong Seok Lee, Hwaseong-si (KR); Huen Sick Min, Hwaseong-si (KR); Jeon Woong Kang, Hwaseong-si (KR)

(21) Appl. No.: 18/830,883

(22) Filed: Sep. 11, 2024

(30) Foreign Application Priority Data
Jun. 3, 2024 (KR) 10-2024-0072628

(51) Int. Cl. B62D 25/14; B60R 16/04; B62D 1/16; B62D 21/15; H01M 50/242; H01M 50/249

(52) U.S. Cl. CPC B62D 25/145; B60R 16/04; B62D 1/16; B62D 21/157; H01M 50/242; H01M 50/249; H01M 2220/20

(57) ABSTRACT

An embodiment front structure for a vehicle includes a dash panel configured to partition a passenger compartment of the vehicle from a front compartment of the vehicle, a pair of front side members extending from the dash panel toward a front end of the vehicle, a dash crossmember fixed to a front surface of the dash panel and extending in a width direction of the vehicle, and a dust cover including an opening configured to receive a steering column extending therethrough, wherein the dust cover and the dash crossmember are components of a unitary one-piece structure.

### CROSS-REFERENCE TO RELATED APPLICATIONS

This application claims the benefit of Korean Patent Application No. 10-2024-0072628, filed on Jun. 3, 2024, which application is hereby incorporated herein by reference in its entirety.

### TECHNICAL FIELD

The present disclosure relates to a vehicle front structure.

### BACKGROUND

A vehicle may include a dash panel by which a passenger compartment and a front compartment are partitioned. A front surface of the dash panel may face the front compartment, and a rear surface of the dash panel may face the passenger compartment. A powertrain system including a prime mover may be disposed in the front compartment. For example, an internal combustion engine vehicle may have a mechanical powertrain system including an internal combustion engine and a transmission in the front compartment, and an electric vehicle may have an electric powertrain system including an electric motor, an inverter, and a transmission in the front compartment.

The electric vehicle may include a battery disposed below a floor of the vehicle, and various reinforcing members may be used for safely protecting the battery during a collision/impact of a vehicle.

The vehicle may include a dash crossmember fixed to the front surface of the dash panel, and the dash crossmember may extend in a width direction of the vehicle. The dash crossmember may define a load path in the width direction of the vehicle and may be made of a high strength material to improve stiffness of the vehicle. A steering column may extend from the passenger compartment to the front compartment through the dash panel and the dash crossmember. The dash panel may have an opening through which the steering column extends, and a dust cover may be aligned with the opening of the dash panel. A U-joint of the steering column may be received and mounted in the dust cover. The dust cover may be fixed to one end portion of the dash crossmember by welding and/or the like. To receive the U-joint of the steering column, the dust cover may have a structure with a relatively great depth and a relatively small thickness, and the dust cover may be made of a soft steel material. The dust cover made of a soft steel material may disconnect the load path defined by the dash crossmember made of a high strength material.

As the dust cover disconnects the load path defined by the dash crossmember, loads may not be uniformly distributed from the dash panel to various structural members in the event of a frontal collision or offset collision of the vehicle. As a result, a lower portion of the dash panel may be excessively deformed, and the deformed lower portion of the dash panel may hit the battery.

The above information described in this background section is provided to assist in understanding the background of the inventive concept, and it may include any technical concept which is not considered as the already known prior art.

### SUMMARY

The present disclosure relates to a vehicle front structure. Particular embodiments relate to a vehicle front structure designed to uniformly distribute loads in various directions during a collision/impact of a vehicle.

Embodiments of the present disclosure can solve problems occurring in the prior art while advantages achieved by the prior art are maintained intact.

An embodiment of the present disclosure provides a vehicle front structure designed to uniformly distribute loads acting on a dash panel in various directions during a collision/impact of a vehicle, thereby preventing a lower portion of the dash panel from being excessively deformed, and thus safely protecting a battery disposed below a floor of the vehicle.

According to an embodiment of the present disclosure, a vehicle front structure may include a dash panel configured to partition a passenger compartment from a front compartment, a pair of front side members extending from the dash panel toward the front of a vehicle, a dash crossmember fixed to a front surface of the dash panel and extending in a width direction of the vehicle, and a dust cover having an opening through which a steering column extends. The dust cover and the dash crossmember may form a unitary one-piece structure.

The dust cover may be adjacent to at least one end portion of the dash crossmember.

A rear end of each front side member may be connected to the dash crossmember.

A rear flange of each front side member may be fixed to the dash crossmember.

The vehicle front structure may further include a pair of inner support members fixed to a rear surface of the dash panel. Each inner support member may extend in a height direction of the dash panel.

The pair of inner support members may be aligned with the pair of front side members, respectively.

A top flange of each inner support member may be aligned with a top flange or bottom flange of the dash crossmember.

The vehicle front structure may further include an inner transverse member connecting the pair of inner support members. The inner transverse member may extend in the width direction of the vehicle.

The vehicle front structure may further include a plurality of inner reinforcing members extending from the inner transverse member toward a floor of the vehicle.

### BRIEF DESCRIPTION OF THE DRAWINGS

The above and other objects, features, and advantages of embodiments of the present disclosure will be more apparent from the following detailed description taken in conjunction with the accompanying drawings, in which:

FIG. 1 illustrates a perspective view of a vehicle front structure according to an exemplary embodiment of the present disclosure;

FIG. 2 illustrates a perspective view of a dash crossmember of a vehicle front structure according to an exemplary embodiment of the present disclosure;

FIG. 3 illustrates a view, which is viewed in a direction indicated by arrow A of FIG. 1;

FIG. 4 illustrates a view, which is viewed in a direction indicated by arrow B of FIG. 1;

FIG. 5 illustrates a perspective view of a state in which a rear end of a front side member is mounted on a dash crossmember in a vehicle front structure according to an exemplary embodiment of the present disclosure;

FIG. 6 illustrates a perspective view of a pair of front side members, a dash crossmember, and an inner support structure in a vehicle front structure according to an exemplary embodiment of the present disclosure; and

FIG. 7 illustrates a cross-sectional view, taken along line C-C of FIG. 3.

### DETAILED DESCRIPTION OF ILLUSTRATIVE EMBODIMENTS

Hereinafter, exemplary embodiments of the present disclosure will be described in detail with reference to the accompanying drawings. In the drawings, the same reference numerals will be used throughout to designate the same or equivalent elements. In addition, a detailed description of well-known techniques associated with the present disclosure will be omitted in order not to unnecessarily obscure the gist of the present disclosure.

Terms such as first, second, A, B, (a), and (b) may be used to describe the elements in exemplary embodiments of the present disclosure. These terms are only used to distinguish one element from another element, and the intrinsic features, sequence, order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art and are not to be interpreted as having ideal or excessively formal meanings unless clearly defined as having such in the present application.

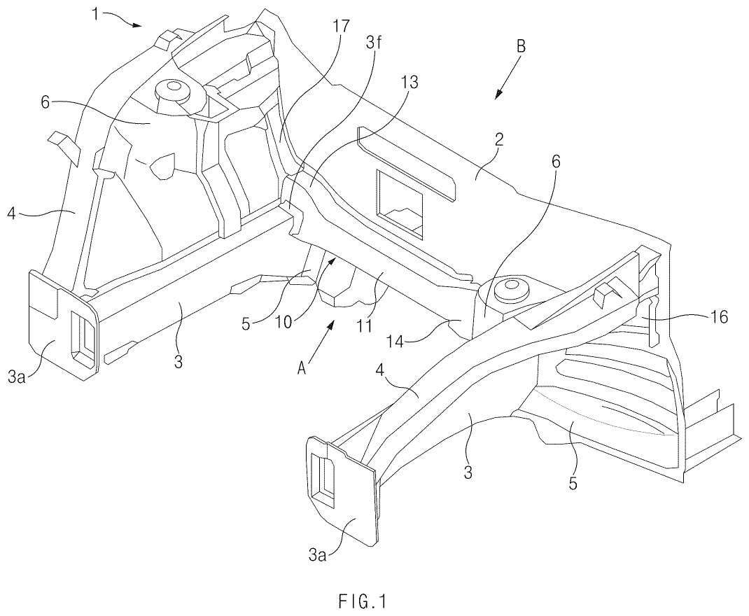

Referring to FIG. 1, a vehicle front structure 1 according to an exemplary embodiment of the present disclosure may include a dash panel 2, a pair of front side members 3 extending from the dash panel 2 toward the front of the vehicle, and a dash crossmember 10 fixed to a front surface of the dash panel 2.

The dash panel 2 may be configured to partition a front compartment from a passenger compartment, and a floor may be connected to a bottom edge of the dash panel 2. A battery may be disposed below the floor.

Each front side member 3 may extend from the dash panel 2 toward the front of the vehicle in a longitudinal direction of the vehicle, and the pair of front side members 3 may be spaced apart from each other in a width direction of the vehicle. Each front side member 3 may have a mounting plate 3a provided on a front end thereof.

A pair of rear lower members 5 may be connected to rear ends of the pair of front side members 3, respectively. Each rear lower member 5 may be fixed to a lower portion of the dash panel 2, and a rear end of each rear lower member 5 may be connected to a side sill.

Referring to FIG. 1, a pair of fender apron members 4 may be spaced apart from each other in the width direction of the vehicle, and each fender apron member 4 may extend toward the front of the vehicle in the longitudinal direction of the vehicle. Each fender apron member 4 may be disposed outward from the corresponding front side member 3 toward the exterior of the vehicle, and a front end of the fender apron member 4 may be mounted on the mounting plate 3a of the corresponding front side member 3. The fender apron member 4 may be located above the corresponding front side member 3, and the fender apron member 4 may be curved toward the front end of the corresponding front side member 3.

Referring to FIG. 1, a pair of damper housings 6 may be mounted on the pair of fender apron members 4, respectively, and an upper portion of a suspension damper such as a shock absorber may be mounted in each damper housing 6. Each damper housing 6 may be connected transverse to the fender apron member 4 and the adjacent front side member 3. A top edge of the damper housing 6 may be fixed to the fender apron member 4, and a bottom edge of the damper housing 6 may be fixed to the front side member 3.

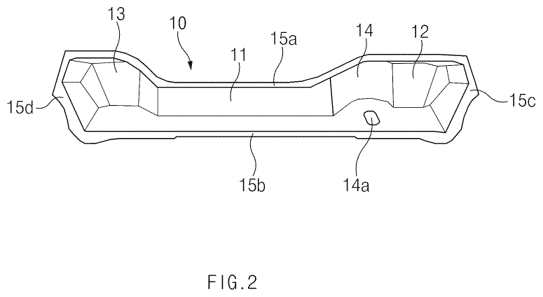

The dash crossmember 10 may extend in the width direction of the vehicle. Referring to FIG. 2, the dash crossmember 10 may include a main body 11 and a pair of end portions 12 and 13. The dash crossmember 10 may have a cavity defined therein.

The main body 11 may extend in the width direction of the vehicle, and the main body 11 may have a length corresponding to a distance between the pair of front side members 3 or a width of the dash panel 2.

A first end portion 12 may be integrally connected to the main body 11, and a cross section (or width) of the first end portion 12 may be greater than or similar to a cross section (or width) of the main body 11. Referring to FIG. 2, the first end portion 12 may be an expanded end portion with a cross section greater than that of the main body 11.

A second end portion 13 may be integrally connected to the main body 11, and a cross section (or width) of the second end portion 13 may be greater than or similar to the cross section (or width) of the main body 11. Referring to FIG. 2, the second end portion 13 may be an expanded end portion with a cross section greater than that of the main body 11.

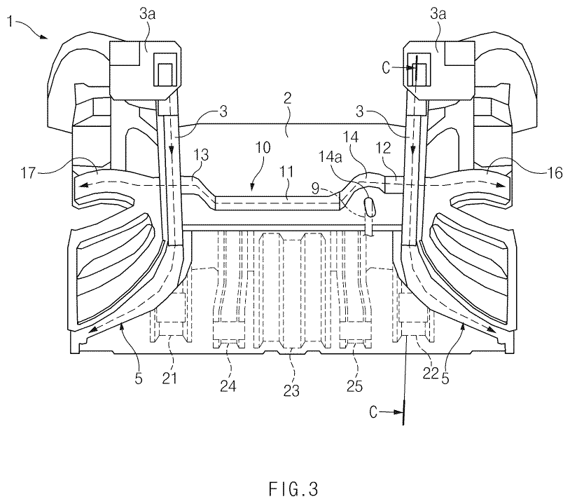

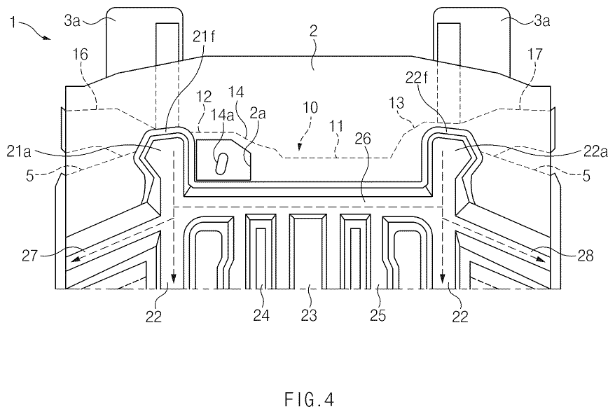

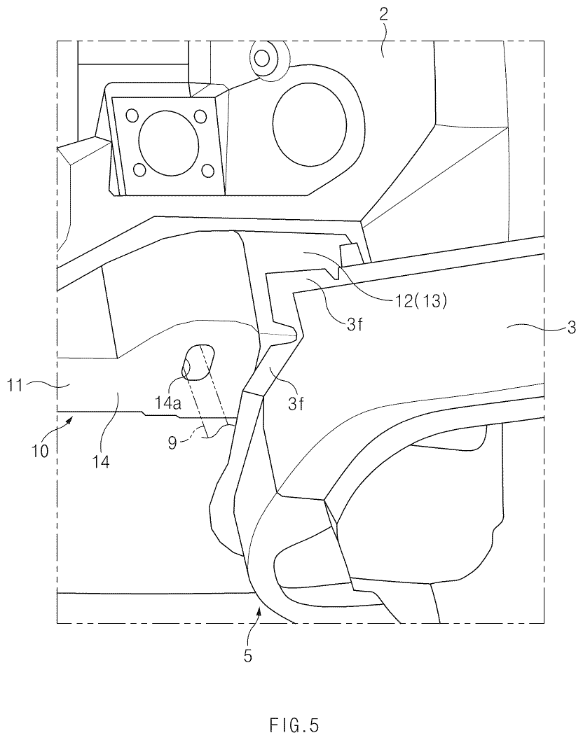

The dash crossmember 10 may include a dust cover 14 receiving a portion of a steering column 9 (see FIGS. 3 and 5). The dust cover 14 may have a cavity defined therein, and the cavity of the dust cover 14 may communicate with the cavity of the dash crossmember 10. The dust cover 14 may be made of the same high-strength material as that of the dash crossmember 10 and may form a unitary one-piece structure with the dash crossmember 10 by various manufacturing methods such as casting, pressing, and the like. The dust cover 14 may have an opening 14a through which the steering column 9 extends. The steering column 9 may extend from a steering wheel located at a driver seat of the passenger compartment to the front compartment through an opening 2a of the dash panel 2 and the opening 14a of the dust cover 14 of the dash crossmember 10. Referring to FIG. 4, the dust cover 14 may be aligned with the opening 2a of the dash panel 2, and accordingly the opening 14a of the dust cover 14 may be aligned with the opening 2a of the dash panel 2. For example, the cavity of the dust cover 14 may receive a U-joint of the steering column 9, and the U-joint of the steering column 9 may be mounted in the cavity of the dust cover 14. The steering column 9 may extend through the opening 2a of the dash panel 2 and the opening 14a of the dust cover 14.

The dust cover 14 may be adjacent to any one of the first and second end portions 12 and 13 of the dash crossmember 10. The dust cover 14 and the dash crossmember 10 may form a unitary one-piece structure.

According to the exemplary embodiment illustrated in FIG. 2, the dust cover 14 may be adjacent to the first end portion 12 of the dash crossmember 10. The dust cover 14 may be integrally connected to the first end portion 12 of the dash crossmember 10. In particular, the dust cover 14 may be integrally provided between the main body 11 and the first end portion 12.

According to another exemplary embodiment, the dust cover 14 may be adjacent to the second end portion 13 of the dash crossmember 10. The dust cover 14 may be integrally connected to the second end portion 13 of the dash crossmember 10. In particular, the dust cover 14 may be integrally provided between the main body 11 and the second end portion 13.

Referring to FIGS. 3 and 4, the first and second end portions 12 and 13 of the dash crossmember 10 may be aligned with the rear ends of the pair of front side members 3, respectively. The first end portion 12 may face the driver seat, and the first end portion 12 may be aligned with the rear end of one front side member 3 facing the driver seat. The second end portion 13 may face a front passenger seat, and the second end portion 13 may be aligned with the rear end of the other front side member 3 facing the front passenger seat.

Referring to FIG. 2, the dash crossmember 10 may have a top flange 15a provided on a top edge thereof, a bottom flange 15b provided on a bottom edge thereof, and a pair of side flanges 15c and 15d provided on both side edges thereof. The top flange 15a may extend along a top edge of the main body 11, a top edge of the first end portion 12, a top edge of the second end portion 13, and a top edge of the dust cover 14. The bottom flange 15b may extend along a bottom edge of the main body 11, a bottom edge of the first end portion 12, a bottom edge of the second end portion 13, and a bottom edge of the dust cover 14. A first side flange 15c may extend along a side edge of the first end portion 12, and a second side flange 15d may extend along a side edge of the second end portion 13. The top flange 15a, the bottom flange 15b, and the pair of side flanges 15c and 15d may be fixed to the front surface of the dash panel 2 using fasteners, welding, and/or the like.

Since the main body 11 of the dash crossmember 10 extends in the width direction of the vehicle, the dash crossmember 10 may define a load path extending in the width direction of the vehicle.

Referring to FIGS. 3 and 4, the vehicle front structure 1 according to an exemplary embodiment of the present disclosure may further include a pair of extension portions 16 and 17 provided at both ends of the dash crossmember 10, and the pair of extension portions 16 and 17 may be fixed to the front surface of the dash panel 2. A first extension portion 16 may extend from the first end portion 12 of the dash crossmember 10 toward the exterior of the vehicle, and a second extension portion 17 may extend from the second end portion 13 of the dash crossmember 10 toward the exterior of the vehicle. Accordingly, the first extension portion 16, the dash crossmember 10, and the second extension portion 17 may define a load path extending in the width direction of the vehicle.

As described above, as the dust cover 14 and the dash crossmember 10 form a unitary one-piece structure, the load path defined by the dash crossmember 10 may be continuous without disconnection. Accordingly, loads may be uniformly distributed through the load path defined by the dash crossmember 10 during a collision/impact of the vehicle so that crashworthiness, stiffness, and the like of the vehicle body may be improved.

The rear end of each front side member 3 may be fixed to the dash crossmember 10 using fasteners, welding, and/or the like.

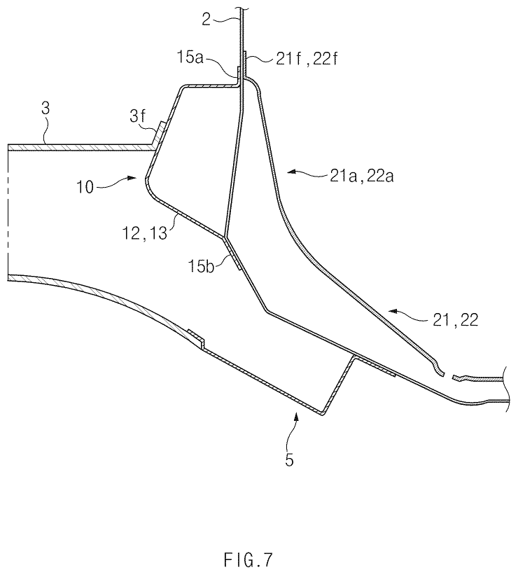

According to the exemplary embodiment illustrated in FIGS. 5 and 7, when a length of the dash crossmember 10 is the same as or similar to the distance between the pair of front side members 3, the rear ends of the front side members 3 may be fixed to the corresponding end portions 12 and 13 of the dash crossmember 10 using fasteners, welding, and/or the like, respectively. Each front side member 3 may have a rear flange 3f provided on the rear end thereof. The rear flange 3f of each front side member 3 may be fixed to the corresponding end portion of the dash crossmember 10 using fasteners, welding, and/or the like.

According to another exemplary embodiment, when the length of the dash crossmember 10 is greater than the distance between the pair of front side members 3, the rear ends of the front side members 3 may be fixed to portions of the main body 11 adjacent to the corresponding end portions 12 and 13 of the dash crossmember 10 using fasteners, welding, and/or the like, respectively. Specifically, the rear flange 3f of each front side member 3 may be fixed to a portion of the main body 11 adjacent to the corresponding end portion of the dash crossmember 10 using fasteners, welding, and/or the like.

As described above, the rear ends of the pair of front side members 3 may be fixed to the corresponding end portions 12 and 13 of the dash crossmember 10 or the main body 11 so that the pair of front side members 3 may be firmly supported to the dash crossmember 10. Thus, the front side members 3 may be sufficiently deformed during a collision/impact of the vehicle so that impact energy may be effectively absorbed or transferred.

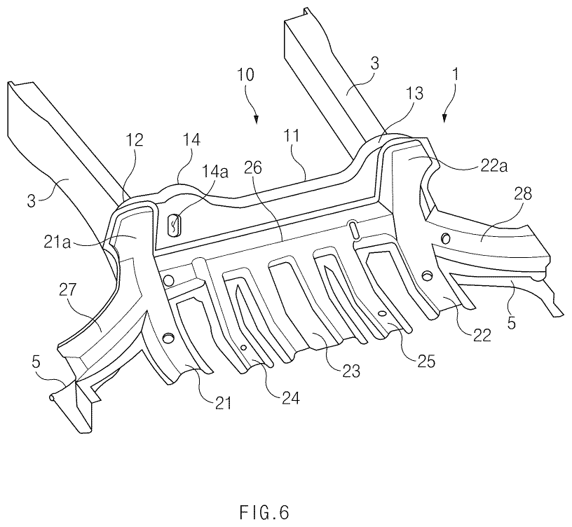

Referring to FIGS. 4 and 6, the vehicle front structure 1 according to an exemplary embodiment of the present disclosure may further include a pair of inner support members 21 and 22 fixed to a rear surface of the dash panel 2. The pair of inner support members 21 and 22 may be spaced apart from each other in the width direction of the vehicle, and each of the inner support members 21 and 22 may extend in a height direction of the dash panel 2, and accordingly each of the inner support members 21 and 22 may define a load path extending in the height direction of the vehicle. The pair of inner support members 21 and 22 may be aligned with the pair of front side members 3, respectively.

Referring to FIG. 6, the inner support members 21 and 22 may be aligned with the corresponding end portions 12 and 13 of the dash crossmember 10 or portions of the main body 11 adjacent to the end portions 12 and 13 of the dash crossmember 10, and thus the pair of inner support members 21 and 22 may stably support the dash crossmember 10 and the pair of front side members 3.

A first inner support member 21 may have a first upper end portion 21a aligned with the rear end of one front side member 3, and a cross section (or width) of the first upper end portion 21a may be greater than or equal to a cross section (or width) of the first inner support member 21. The first upper end portion 21a of the first inner support member 21 may be at least partially overlapped with the first end portion 12 of the dash crossmember 10 or the portion of the main body 11 adjacent to the first end portion 12. A second inner support member 22 may have a second upper end portion 22a aligned with the rear end of the other front side member 3, and a cross section (or width) of the second upper end portion 22a may be greater than or equal to a cross section (or width) of the second inner support member 22. The second upper end portion 22a of the second inner support member 22 may be at least partially overlapped with the second end portion 13 of the dash crossmember 10 or the portion of the main body 11 adjacent to the second end portion 13.

Top flanges 21f and 22f of the inner support members 21 and 22 may be aligned with the top flange 15a or the bottom flange 15b of the dash crossmember 10. Referring to FIG. 7, the rear flanges 3f of the front side members 3 may be fixed to the corresponding end portions 12 and 13 of the dash crossmember 10, respectively, the first upper end portion 21a of the first inner support member 21 may be aligned with the first end portion 12 of the dash crossmember 10, and the second upper end portion 22a of the second inner support member 22 may be aligned with the second end portion 13 of the dash crossmember 10. The top flanges 21f and 22f extending from the upper end portions 21a and 22a of the inner support members 21 and 22 may be aligned with the top flange 15a extending from the corresponding end portions 12 and 13 of the dash crossmember 10.

As described above, the rear ends of the front side members 3 may be connected to the inner support members 21 and 22 through the dash panel 2 and the end portions 12 and 13 of the dash crossmember 10 so that the pair of front side members 3 may be firmly supported to the dash crossmember 10 and the pair of inner support members 21 and 22. Thus, the front side members 3 may be sufficiently deformed during a collision/impact of the vehicle so that impact energy may be effectively absorbed or transferred.

Referring to FIGS. 4 and 6, the vehicle front structure 1 according to an exemplary embodiment of the present disclosure may further include a pair of inner extension members 27 and 28 extending from the pair of inner support members 21 and 22, respectively. The first inner extension member 27 may extend from the first inner support member 21 toward the exterior of the vehicle, and the second inner extension member 28 may extend from the second inner support member 22 toward the exterior of the vehicle. The inner extension members 27 and 28 may be aligned with the corresponding rear lower members 5, respectively.

Referring to FIGS. 4 and 6, the vehicle front structure 1 according to an exemplary embodiment of the present disclosure may further include an inner transverse member 26 connecting the pair of inner support members 21 and 22, and the inner transverse member 26 may be fixed to the rear surface of the dash panel 2. The inner transverse member 26 may extend in the width direction of the vehicle, and the inner transverse member 26 may define a load path extending in the width direction of the vehicle. The inner transverse member 26 may be at least partially overlapped or aligned with the dash crossmember 10. The inner transverse member 26 may be connected to the dash crossmember 10 through the dash panel 2.

Referring to FIGS. 4 and 6, the vehicle front structure 1 according to an exemplary embodiment of the present disclosure may further include a plurality of inner reinforcing members 23, 24, and 25 extending from the inner transverse member 26 toward the floor of the vehicle. The plurality of inner reinforcing members 23, 24, and 25 may include an inner center reinforcing member 23 extending from the center of the inner transverse member 26 toward the floor of the vehicle and a pair of inner side reinforcing members 24 and 25 symmetrically disposed on both sides of the inner center reinforcing member 23. A first inner side reinforcing member 24 may be adjacent to the first inner support member 21, and a second inner side reinforcing member 25 may be adjacent to the second inner support member 22. The inner center reinforcing member 23, the first inner side reinforcing member 24, and the second inner side reinforcing member 25 may define a plurality of load paths extending from the rear surface of the dash panel 2 in the height direction of the vehicle.

As described above, the pair of inner support members 21 and 22 may support the pair of front side members 3 and the dash crossmember 10 on the rear surface of the dash panel 2, and the pair of inner support members 21 and 22, the inner transverse member 26, and the plurality of inner reinforcing members 23, 24, and 25 may define the load paths in various directions on the rear surface of the dash panel 2, thereby uniformly distributing the loads acting on the dash panel 2 in various directions during a collision/impact of the vehicle.

According to the above-described exemplary embodiments of the present disclosure, the dust cover 14 together with the dash crossmember 10 may form a unitary one-piece structure so that the dust cover 14 may not disconnect the load path defined by the dash crossmember 10, and thus the dash crossmember 10 and the dust cover 14 may continuously define the load path extending in the width direction of the vehicle. Accordingly, during a collision/impact of the vehicle, the loads transferred to the dash panel 2 through the pair of front side members 3 may be uniformly distributed in various directions so that the lower portion of the dash panel 2 may be prevented from being excessively deformed, and thus the battery disposed below the floor may be safely protected. According to the related art, various reinforcing members and structural changes may be used to protect the battery, leading to increases in weight and manufacturing cost of the vehicle. However, according to exemplary embodiments of the present disclosure, the dust cover 14 and the dash crossmember 10 may form a unitary one-piece structure so that the weight, manufacturing cost, and the like of the vehicle may be significantly reduced.

As set forth above, the vehicle front structure according to exemplary embodiments of the present disclosure may be designed to allow the dust cover and the dash crossmember to form a unitary one-piece structure so that the dust cover may not disconnect the load path defined by the dash crossmember, but the dash crossmember and the dust cover may continuously define the load path extending in the width direction of the vehicle. Accordingly, the vehicle front structure may cause the loads transferred to the dash panel through the pair of front side members to be uniformly distributed in various directions during a collision/impact of the vehicle, thereby preventing the lower portion of the dash panel from being excessively deformed, and safely protecting the battery disposed below the floor.

Hereinabove, although embodiments of the present disclosure have been described with reference to exemplary embodiments and the accompanying drawings, the present disclosure is not limited thereto, but it may be variously modified and altered by those skilled in the art to which the present disclosure pertains without departing from the spirit and scope of the present disclosure claimed in the following claims.

What is claimed is:

1. A front structure for a vehicle, the front structure comprising:
a dash panel configured to partition a passenger compartment of the vehicle from a front compartment of the vehicle;
a pair of front side members extending from the dash panel toward a front end of the vehicle;
a dash crossmember fixed to a front surface of the dash panel and extending in a width direction of the vehicle; and
a dust cover including an opening configured to receive a steering column extending therethrough, wherein the dust cover and the dash crossmember are components of a unitary one-piece structure.

2. The front structure according to claim 1, wherein the dust cover is adjacent to an end portion of the dash crossmember.

3. The front structure according to claim 1, wherein a rear end of each front side member is connected to the dash crossmember.

4. The front structure according to claim 1, wherein a rear flange of each front side member is fixed to the dash crossmember.

5. The front structure according to claim 1, further comprising a pair of inner support members fixed to a rear surface of the dash panel, wherein each inner support member extends in a height direction of the dash panel.

6. The front structure according to claim 5, wherein the inner support members are aligned with the front side members, respectively.

7. The front structure according to claim 5, wherein a top flange of each inner support member is aligned with a top flange of the dash crossmember.

8. The front structure according to claim 5, wherein a top flange of each inner support member is aligned with a bottom flange of the dash crossmember.

9. The front structure according to claim 5, further comprising an inner transverse member connecting the pair of inner support members, wherein the inner transverse member extends in the width direction of the vehicle.

10. The front structure according to claim 9, further comprising a plurality of inner reinforcing members extending downward from the inner transverse member.

11. A front structure for a vehicle, the front structure comprising:
a dash panel configured to partition a passenger compartment of the vehicle from a front compartment of the vehicle;
a pair of front side members extending from the dash panel toward a front end of the vehicle;
a dash crossmember fixed to a front surface of the dash panel and extending in a width direction of the vehicle;
a dust cover disposed adjacent to an end portion of the dash crossmember and including an opening configured to receive a steering column extending therethrough, wherein the dust cover and the dash crossmember are components of a unitary one-piece structure; and
a pair of inner support members fixed to a rear surface of the dash panel, wherein each inner support member extends in a height direction of the dash panel.

12. The front structure according to claim 11, wherein the inner support members are aligned with front side members, respectively.

13. The front structure according to claim 11, wherein a top flange of each inner support member is aligned with a top flange of the dash crossmember.

14. The front structure according to claim 11, wherein a top flange of each inner support member is aligned with a bottom flange of the dash crossmember.

15. The front structure according to claim 11, further comprising an inner transverse member connecting the pair of inner support members, wherein the inner transverse member extends in the width direction of the vehicle.

16. The front structure according to claim 15, further comprising a plurality of inner reinforcing members extending downward from the inner transverse member.

17. A vehicle comprising:
a vehicle body;
a dash panel disposed inside the vehicle, extending in a width direction of the vehicle, and partitioning a passenger compartment of the vehicle from a front compartment of the vehicle;
a pair of front side members spaced apart from each other in the width direction of the vehicle and extending from each end of the dash panel toward a front end of the vehicle;
a dash crossmember fixed to a front surface of the dash panel and extending in the width direction of the vehicle, wherein the dash crossmember is a unitary one-piece structure, and wherein the dash crossmember comprises:
a main body;
a first end portion and a second end portion integrally connected to opposite ends of the main body, respectively; and
a dust cover integrally connected to the first end portion or the second end portion and including an opening;
a steering column extending through the opening in the dust cover;
a floor connected to a bottom edge of the dash panel; and
a battery disposed below the floor.

18. The vehicle according to claim 17, further comprising:
a pair of inner support members fixed to a rear surface of the dash panel, wherein each inner support member extends in a height direction of the dash panel;
an inner transverse member connecting the pair of inner support members, wherein the inner transverse member extends in the width direction of the vehicle; and
a plurality of inner reinforcing members extending downward from the inner transverse member toward the floor of the vehicle.
